(19) United States
(12) Patent Application Publication
(10) Pub. No.: US 2021/0244499 A1
(43) Pub. Date: Aug. 12, 2021

(54) Laser Emitting Orthodontic Assembly

(71) Applicant: Dheyaa Obada, Elmwood Park, IL (US)

(72) Inventor: Dheyaa Obada, Elmwood Park, IL (US)

(21) Appl. No.: 16/787,713

(22) Filed: Feb. 11, 2020

(51) Int. Cl. A61C 1/00; B23K 26/03; A61C 5/42

(52) U.S. Cl. CPC A61C 1/0046; A61C 5/42; B23K 26/032

(57) ABSTRACT

A laser emitting orthodontic assembly includes a plurality of reamers that is each insertable into a root canal in a tooth. A plurality of files is provided and each of the files is insertable into a root canal in the tooth. Each of the files has a diameter that is greater than the largest diameter of the plurality of reamers thereby facilitating the files to increase the diameter of the root canal. A laser generator is provided that emits laser light outwardly therefrom. A fiber optic cable is attachable to the output of the laser generator to communicate the laser light. The fiber optic cable is insertable into the root canal to communicate the laser light onto an abscess for eliminating the abscess without conventional surgical intervention.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to orthodontic devices and more particularly pertains to a new orthodontic device for performing a root canal dental procedure with a non-invasive laser.

### (2) Description of Related Art Including Information Disclosed Under 37 CFR 1.97 and 1.98

The prior art relates to orthodontic devices. The prior art discloses a laser emitter for boring a hole into a tooth. The prior art discloses a dental laser emitter that includes a sleeve through which a fiber optic cable for a laser is extended for manipulating the fiber optic cable during a dental procedure. Additionally, the prior art discloses a variety of dental lasers, each emitting laser light capable of eradicating lesions in teeth. Each of the dental lasers discloses has novel structural elements with respect to each other. In no case does the prior art disclose a dental laser combined with a plurality of files and a plurality of reamers.

### BRIEF SUMMARY OF THE INVENTION

An embodiment of the disclosure meets the needs presented above by generally comprising a plurality of reamers that is each insertable into a root canal in a tooth. A plurality of files is provided and each of the files is insertable into a root canal in the tooth. Each of the files has a diameter that is greater than the largest diameter of the plurality of reamers thereby facilitating the files to increase the diameter of the root canal. A laser generator is provided that emits laser light outwardly therefrom. A fiber optic cable is attachable to the output of the laser generator to communicate the laser light. The fiber optic cable is insertable into the root canal to communicate the laser light onto an abscess for eliminating the abscess without conventional surgical intervention.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a laser emitting orthodontic assembly according to an embodiment of the disclosure.

FIG. 2 is a perspective in-use view of an embodiment of the disclosure showing a reamer being inserted into a root canal of a tooth.

FIG. 3 is a perspective in-use view of an embodiment of the disclosure showing a fiber optic cable directing a laser beam onto an abscess in a root canal of a tooth.

### DETAILED DESCRIPTION OF THE INVENTION

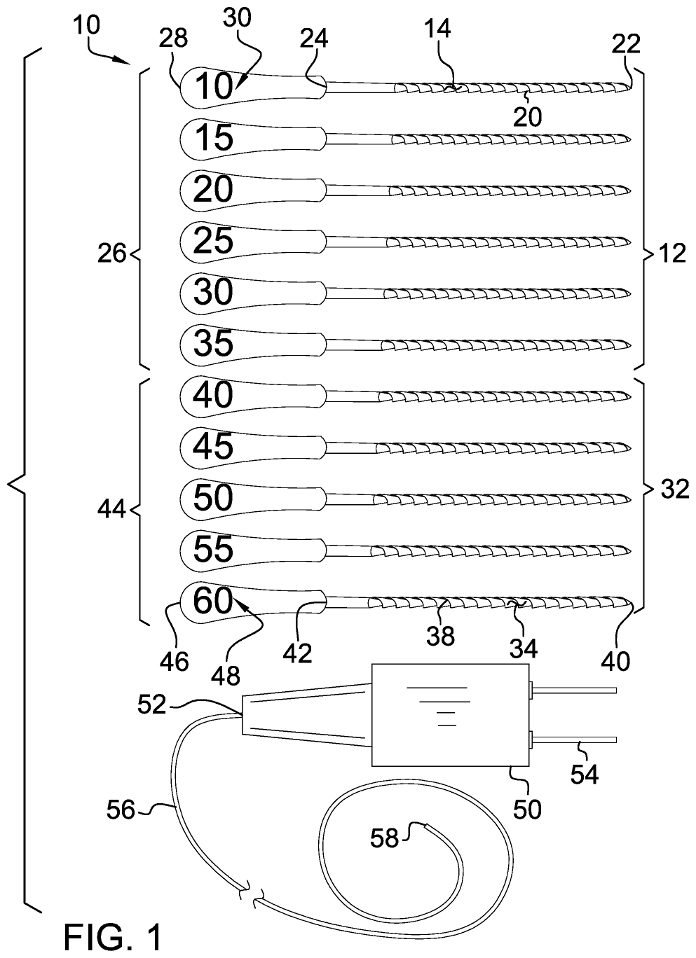

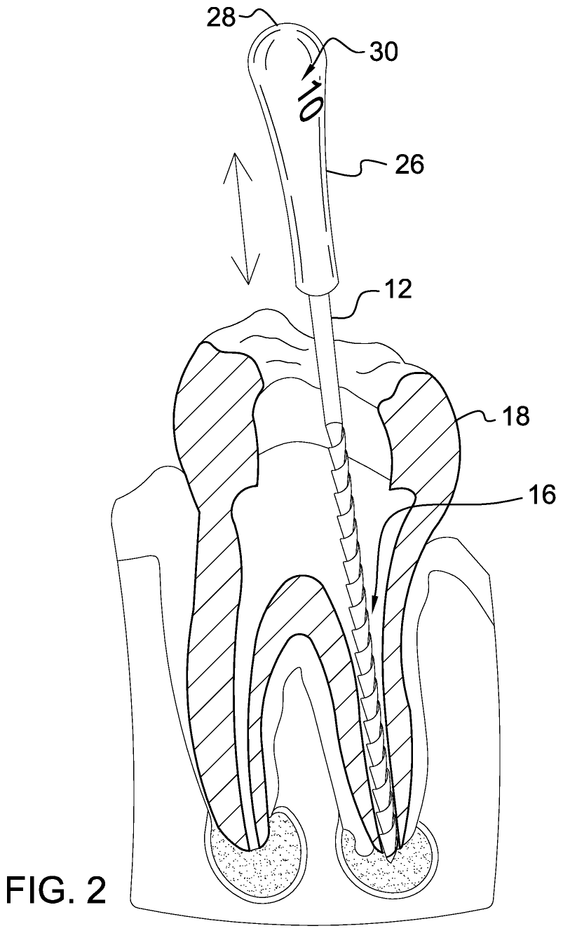

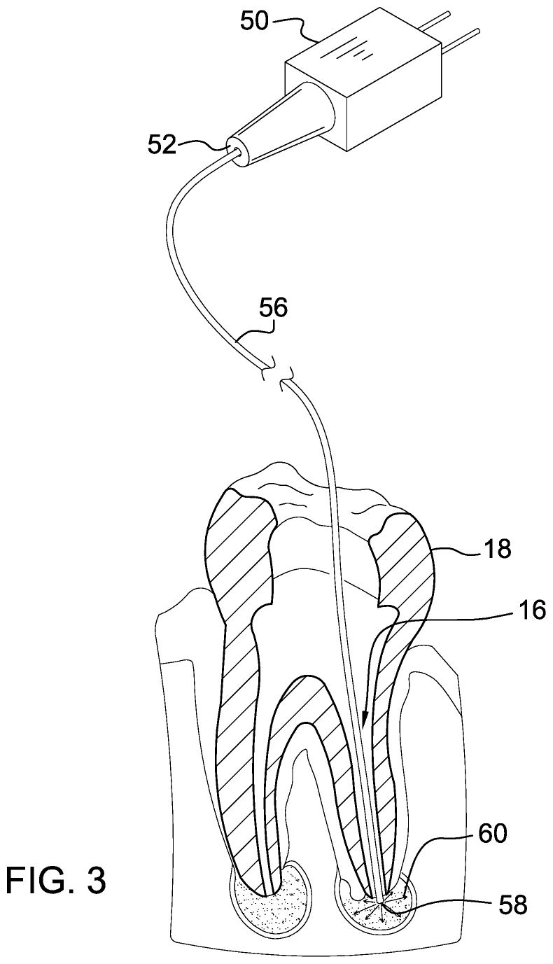

With reference now to the drawings, and in particular to FIGS. 1 through 3 thereof, a new orthodontic device embodying the principles and concepts of an embodiment of the disclosure and generally designated by the reference numeral 10 will be described.

As best illustrated in FIGS. 1 through 3, the laser emitting orthodontic assembly 10 generally comprises a plurality of reamers 12 that each has a textured outside surface 14 for abrading a root canal 16 in a tooth 18. The outside surface 14 may have a groove 20 that spirals around the outside surface 14 to define a screw-like ridge spiraling around each of the reamers 12. Each of the reamers 12 has a unique diameter with respect to each other to accommodate varying anatomy of root canals in teeth. Moreover, each of the reamers 12 has a first end 22 and a second end 24, and the first end 22 of each of the reamers 12 tapers to a point. Each of said reamers 12 has a maximum length of 32.0 mm to reach fully into the root canal 16.

A plurality of reamer handles 26 is each coupled to a respective one of the reamers 12 for gripping to insert the respective reamer 12 into the root canal 16. Each of the reamer handles 26 is positioned on the second end of the respective reamer 12. Additionally, each of the reamer handles 26 has a bulbous distal end 28 to enhance comfort for gripping the reamer handles 26. Each of the reamer handles 26 has indicia 30 printed thereon and the indicia 30 comprise numbers to indicate the diameter of the respective reamer 12.

A plurality of files 32 is provided and each of the files 32 has a textured outside surface 34 to abrade the root canal 16 in a tooth 18. The outside surface 34 of each of the files 32 may have a groove 38 that spirals around the outside surface 34 to define a screw-like ridge spiraling around each of the files 32. Each of the files 32 has a unique diameter with respect to each other to accommodate varying anatomy of root canals in teeth. Moreover, each of the files 32 has a diameter that is greater than the largest diameter of the plurality of reamers 12. In this way each of the files 32 can increase the diameter of the root canal 16 and remove inflamed tissue or infected tissue within the root canal 16. Each of the files 32 has a first end 40 and a second end 42, and the first end 40 of each of the files 32 tapers to a point.

A plurality of file handles 44 is each coupled to a respective one of the files 32 to be gripped to insert the respective file 32 into the root canal 16. Each of the file handles 44 is positioned on the second end of the respective file 32. Additionally, each of the file handles 44 has a bulbous distal end 46 to enhance comfort for gripping the file handles 44. Each of the file handles 44 has indicia 48 printed thereon and the indicia 48 comprise numbers to indicate the diameter of the respective file 32.

A laser generator 50 has an output 52 that emits laser light outwardly therefrom and the laser generator 50 is electrically coupled to a power source 54. The laser generator 50 may generate a laser beam with a wavelength of approximately 810.0 nm. Additionally, the laser generator 50 may produce a laser beam with an intensity that is sufficient to perform approximately 2.0 watts of work. A fiber optic cable 56 is attachable to the output 52 of the laser generator 50 to communicate the laser light. The fiber optic cable 56 has a diameter that is less than the smallest diameter of the plurality of reamers 12. In this way the fiber optic cable 56 can fit into the root canal 16 when the root canal 16 has been reamed and filed.

The fiber optic cable 56 has a distal end 58 with respect to the laser generator 50. Additionally, the fiber optic cable 56 is insertable into the root canal 16 thereby facilitating the distal end 58 of the fiber optic cable 56 to be positioned adjacent to an abscess 60 at the bottom of the root canal 16. In this way the fiber optic cable 56 communicates the laser light onto the abscess 60 for eliminating the abscess 60 without conventional surgical intervention. Thus, a root canal dental procedure can be performed without traditional oral surgical tools and procedures. In this way the root canal dental procedure can be performed with a minimal degree of post operative pain and swelling as compared to existing surgical techniques employed in the conventional method of performing a root canal dental procedure.

In use, a selected one of the reamers 12 is chosen, based upon the diameter of the selected reamer, and the selected reamer is driven downwardly into the root canal 16 of a tooth 18. In this way the selected reamer 12 clears the root canal 16 for subsequently introduction of a selected file 32. The selected file 32 is driven downwardly into the root canal 16 for removing inflamed tissue or infected tissue in the root canal 16. Additionally, the selected file 32 increases the diameter of the root canal 16 for enhancing insertion of the fiber optic cable 56. The fiber optic cable 56 is inserted into the root canal 16 until the distal end 58 of the fiber optic cable 56 is positioned adjacent to an abscess 60 at the root of the tooth 18. The laser generator 50 is turned on to emit the laser light onto the abscess 60 and subsequently disintegrate the abscess 60. In this way the root canal dental procedure can be performed without employing currently existing, invasive surgical techniques.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A laser emitting orthodontic assembly being configured to remove infected tissue associated with a root canal dental procedure, said assembly comprising:
a plurality of reamers, each of said reamers having an textured outside surface wherein each of said reamers is configured to abrade a root canal in a tooth, each of said reamers having a unique diameter with respect to each other wherein said plurality of reamers is configured to accommodate varying anatomy of root canals in teeth;
a plurality of reamer handles, each of said reamer handles being coupled to a respective one of said reamers wherein said reamer handles are configured to be gripped to insert said respective reamer into the root canal;
a plurality of files, each of said files having an textured outside surface wherein each of said files is configured to abrade a root canal in a tooth, each of said files having a unique diameter with respect to each other wherein said plurality of files is configured to accommodate varying anatomy of root canals in teeth, each of said files having a diameter being greater than the largest diameter of said plurality of reamers wherein each of said files is configured to increase the diameter of the root canal;
a plurality of file handles, each of said file handles being coupled to a respective one of said files wherein said file handles are configured to be gripped to insert said respective file into the root canal;
a laser generator having an output being configured to emit laser light outwardly therefrom, said laser generator being electrically coupled to a power source; and
a fiber optic cable being attachable to said output of said laser generator wherein said fiber optic cable is configured to communicate the laser light, said fiber optic cable having a diameter being less than the smallest diameter of said plurality of reamers wherein said fiber optic cable is configured to fit into the root canal when the root canal has been reamed and filed, said fiber optic cable having a distal end with respect to said laser generator, said fiber optic cable being insertable into the root canal thereby facilitating said distal end of said fiber optic cable to be positioned adjacent to an abscess at the bottom of the root canal wherein said fiber optic cable is configured to communicate the laser light onto the abscess for eliminating the abscess without conventional surgical intervention.

2. The assembly according to claim 1, wherein each of said reamers has a first end and a second end, said first end of each of said reamers tapering to a point, each of said reamers having a maximum length of 32.0 mm wherein each of said reamers is configured to reach fully into the root canal.

3. The assembly according to claim 3, wherein each of said reamer handles is positioned on said second end of said respective reamer, each of said reamer handles having a bulbous distal end wherein said bulbous distal end is configured to enhance comfort for gripping said reamer handles.

4. The assembly according to claim 1, wherein each of said reamer handles has indicia being printed thereon, said indicia comprising numbers to indicate the diameter of said respective reamer.

5. The assembly according to claim 1, wherein each of said files has a first end and a second end, said first end of each of said files tapering to a point, each of said files having a maximum length of approximately 32.0 mm wherein said plurality of files is configured to reach fully into the root canal.

6. The assembly according to claim 5, wherein each of said file handles is positioned on said second end of said respective file, each of said file handles has a bulbous distal end wherein said bulbous distal end of each of said file handles is configured to enhance comfort for gripping said file handles.

7. The assembly according to claim 1, wherein each of said file handles has indicia being printed thereon, said indicia comprising numbers to indicate the diameter of said respective file.

8. A laser emitting orthodontic assembly being configured to remove infected tissue associated with a root canal dental procedure, said assembly comprising:
a plurality of reamers, each of said reamers having an textured outside surface wherein each of said reamers is configured to abrade a root canal in a tooth, each of said reamers having a unique diameter with respect to each other wherein said plurality of reamers is configured to accommodate varying anatomy of root canals in teeth, each of said reamers having a first end and a second end, said first end of each of said reamers tapering to a point, each of said reamers having a maximum length of 32.0 mm wherein each of said reamers is configured to reach fully into the root canal;
a plurality of reamer handles, each of said reamer handles being coupled to a respective one of said reamers wherein said reamer handles are configured to be gripped to insert said respective reamer into the root canal, each of said reamer handles being positioned on said second end of said respective reamer, each of said reamer handles having a bulbous distal end wherein said bulbous distal end is configured to enhance comfort for gripping said reamer handles, each of said reamer handles having indicia being printed thereon, said indicia comprising numbers to indicate the diameter of said respective reamer;
a plurality of files, each of said files having an textured outside surface wherein each of said files is configured to abrade a root canal in a tooth, each of said files having a unique diameter with respect to each other wherein said plurality of files is configured to accommodate varying anatomy of root canals in teeth, each of said files having a diameter being greater than the largest diameter of said plurality of reamers wherein each of said files is configured to increase the diameter of the root canal, each of said files having a first end and a second end, said first end of each of said files tapering to a point, each of said files having a maximum length of 32.0 mm wherein each of said files is configured to reach fully into the root canal;
a plurality of file handles, each of said file handles being coupled to a respective one of said files wherein said file handles are configured to be gripped to insert said respective file into the root canal, each of said file handles being positioned on said second end of said respective file, each of said file handles having a bulbous distal end wherein said bulbous distal end of each of said file handles is configured to enhance comfort for gripping said file handles, each of said file handles having indicia being printed thereon, said indicia comprising numbers to indicate the diameter of said respective file;
a laser generator having an output being configured to emit laser light outwardly therefrom, said laser generator being electrically coupled to a power source; and
a fiber optic cable being attachable to said output of said laser generator wherein said fiber optic cable is configured to communicate the laser light, said fiber optic cable having a diameter being less than the smallest diameter of said plurality of reamers wherein said fiber optic cable is configured to fit into the root canal when the root canal has been reamed and filed, said fiber optic cable having a distal end with respect to said laser generator, said fiber optic cable being insertable into the root canal thereby facilitating said distal end of said fiber optic cable to be positioned adjacent to an abscess at the bottom of the root canal wherein said fiber optic cable is configured to communicate the laser light onto the abscess for eliminating the abscess without conventional surgical intervention.
